(19) United States
(12) Patent Application Publication
(10) Pub. No.: US 2014/0311361 A1
(43) Pub. Date: Oct. 23, 2014

(54) DEVICE FOR STORING, MARINATING, TRANSPORTING AND SERVING FOOD INCLUDING WARMING COVER AND CUTTING BOARD AND METHOD THEREFOR

(71) Applicant: Eric J. Wangler, Mendon, NY (US)

(72) Inventor: Eric J. Wangler, Mendon, NY (US)

(21) Appl. No.: 13/867,221

(22) Filed: Apr. 22, 2013

(51) Int. Cl. A47J 39/00; A47J 47/00

(52) U.S. Cl. CPC A47J 39/006; A47J 47/005
USPC 99/472; 99/467

(57) ABSTRACT

An apparatus for marinating a food in a marinade, storing the food during marination, keeping the food warm after cooking, and supporting the food for cutting is provided, the apparatus including a vacuum-sealable marination chamber; a warming chamber; and a cutting board.

### CROSS-REFERENCE TO RELATED APPLICATIONS

This application claims the benefit of U.S. Provisional Patent Application Ser. No. 61/686,654, filed Apr. 10, 2012, which is incorporated by reference herein.

### BACKGROUND OF THE INVENTION

An apparatus for vacuum marinating food such as meat and vegetables, keeping the food warm after cooking, and cutting the cooked food, and which eliminates the need for a separate platter upon which to place the cooked food, and which keeps “raw meat” contamination in a separate, secure compartment.

Marination of food is a well known and commonly performed process of soaking the food in a seasoned, often acidic liquid, prior to cooking. Marination both enhances food flavor, and tenderizes tougher foods, such as cheaper cuts of meat. In particular, acidic marinades break down muscle tissue, allowing marinade fluid to be absorbed, thereby producing a more moist, flavorful product.

Under normal conditions, marination requires an extended period of time, such as 1, 2, 3, 4 or 5-hours or longer. Methods of reducing marination time by application of a pressure differential are well know. U.S. Pat. Nos. 4,818,550 and 5,057,332 to Davidson, et al., and U.S. Pat. No. 3,928,634 to Gasbarro, disclose marinating foodstuffs by forming a negative pressure differential (vacuum) to suck the air out of the food that form spaces within the food into which the marinating liquid may enter and fill. U.S. Pat. No. 6,242,025 to Lesky, et al., discloses marinating foods by applying a positive pressure differential (e.g., increased pressure) that causes the marinating liquids to be infused into the food while air trapped in the food is expelled by the entering liquid.

Devices for vacuum marination of foodstuffs are available for home use. These devices frequently include an air-tight sealable food container and an air pump that attaches to the container and sucks some of the air out of the sealed container, thereby creating a negative pressure differential.

Marination is only one task required to prepare a food for serving. Typically, the food must be cooked, held at an elevated temperature and/or cut up prior to serving. These tasks must also separate the cooked food from the juices released from the raw food, such as but not limited to “raw meat” contamination, including any containers or utensils that contacted the raw food. Commercially available home vacuum marination devices are not designed to be used in any of these additional tasks, and to do so might break the device. Consequently, the home cook must utilize several devices while preparing the marinated food for consumption. These additional devices include but are not limited to additional containers for keeping the food warm and a cutting board or plate on which to place, transport and/or cut the cooked food. Using such additional devices undesirably increases the complexity of meal preparation and the amount of clean up. Accordingly, there is a need for a device that in addition to reducing the time required to marinate a food, separates the cooked food from raw-food-contaminated surfaces, allows for processing of a food from refrigerator, to grill, to table, that allows for warming and cutting the cooked food, and also that allows for easy disassembly of the device for cleaning.

### SUMMARY OF THE INVENTION

In a preferred embodiment, an apparatus for marinating a food in a marinade, storing the food during marination, keeping the food warm after cooking, and supporting the food for cutting is provided, the apparatus including vacuum-sealable marination chamber sized and shaped for receiving a food to be marinated and a marination liquid, the marination chamber including an open position and a closed position; a warming chamber; and a cutting board.

In a further embodiment, the marination chamber includes a base having a floor joined with upstanding walls; a cover having a ceiling joined with downwardly extending walls adapted for reversibly engaging the base; a sealing sub-assembly for forming a vacuum seal between the base and the cover when the marination chamber is in the closed position; and a vacuum port adapted to releasably engage a vacuum pump. The base and the cover are hingeably, or pivotably joined, so that the marination chamber can be opened and closed by pivoting the cover with respect to the base. In a further embodiment, the base includes tip-free legs or support ribs.

In a further embodiment, the marination chamber includes marinating ribs that extend upwardly from the floor. The marinating ribs are sized and shaped such that they lift food received in the marination chamber above the floor. Since the food is lifted off of the floor, the marination liquid flows between the floor and the food, providing substantial contact between a lower surface of the food and the marinating liquid.

In a further embodiment, the sealing sub-assembly includes a base lip and a cover lip, the lips being adapted for reversible overlapping mating engagement; and a food-safe polymer gasket releasably engaged by the lips when the marination chamber is in the closed position.

In a further embodiment, the marination chamber includes a vacuum release structure, for breaking a vacuum within the marination chamber.

In a further embodiment, the marination chamber is reversibly lockable when in the closed position.

In a further embodiment, the marination chamber includes a food-safe polymer. In a still further embodiment, the food-safe polymer is at least one of microwave-safe, dishwasher-safe, and freezer-safe.

In a further embodiment, the cutting board includes an outer surface of the cover ceiling; and reinforcement structure downwardly extending from an inner surface of the cover ceiling.

In a further embodiment, an outer top surface of the cover includes an engagement groove sized and shaped to reversibly receive therein a bottom lip of the warming chamber.

In a further embodiment, the vacuum port includes a removable closure.

In a further embodiment, the warming chamber includes an outer top surface of the cover; and a top portion including a ceiling joined with downwardly extending walls, the top portion being sized and shaped for removably engaging the cover outer top surface, so as to define the warming chamber. In a further embodiment, the top portion includes a vent; and condensation ribs on an inner surface of the top portion ceiling.

In an embodiment, the apparatus further includes a vacuum pump operably engageable with the marination chamber for creation of a vacuum within the marination chamber when the marination chamber is in the closed position.

The drawings constitute a part of this specification and include exemplary embodiments of the present invention and illustrate various objects and features thereof.

### BRIEF DESCRIPTION OF THE DRAWINGS

FIG. 1 is a top perspective view of an exemplary embodiment apparatus of the present invention, in a closed position, the apparatus being useful for marinating a food in a marinade, storing the food during marination, keeping the food warm after cooking and supporting the food for cutting, and with portions of the apparatus being cut away to show some additional detail thereof.

FIG. 2 is a side view of the apparatus of FIG. 1, with portions cut away to show some internal detail of the apparatus.

FIG. 3 is a reduced perspective view of the apparatus of FIG. 1 in the open position.

FIG. 4 is an enlarged perspective view of a portion of the apparatus of FIG. 1 engaging a hand-operated vacuum pump, in one embodiment.

FIG. 5 is an enlarged perspective view of a portion of the apparatus of FIG. 1 illustrating a hinge portion of the apparatus.

FIG. 6 is an enlarged view of a portion of the apparatus of FIG. 2.

FIG. 7 is a rear top perspective view of the apparatus of FIG. 1 illustrating anti-tipping legs of the apparatus.

FIG. 8 is a top perspective view of the apparatus of FIG. 1, in a further embodiment.

### DETAILED DESCRIPTION OF THE INVENTION

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

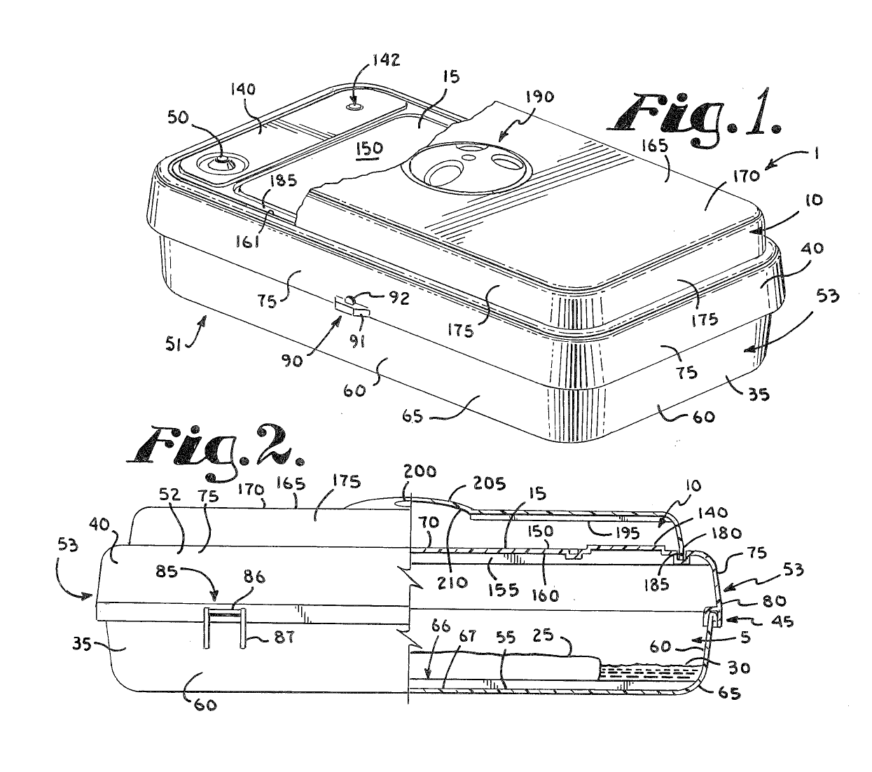

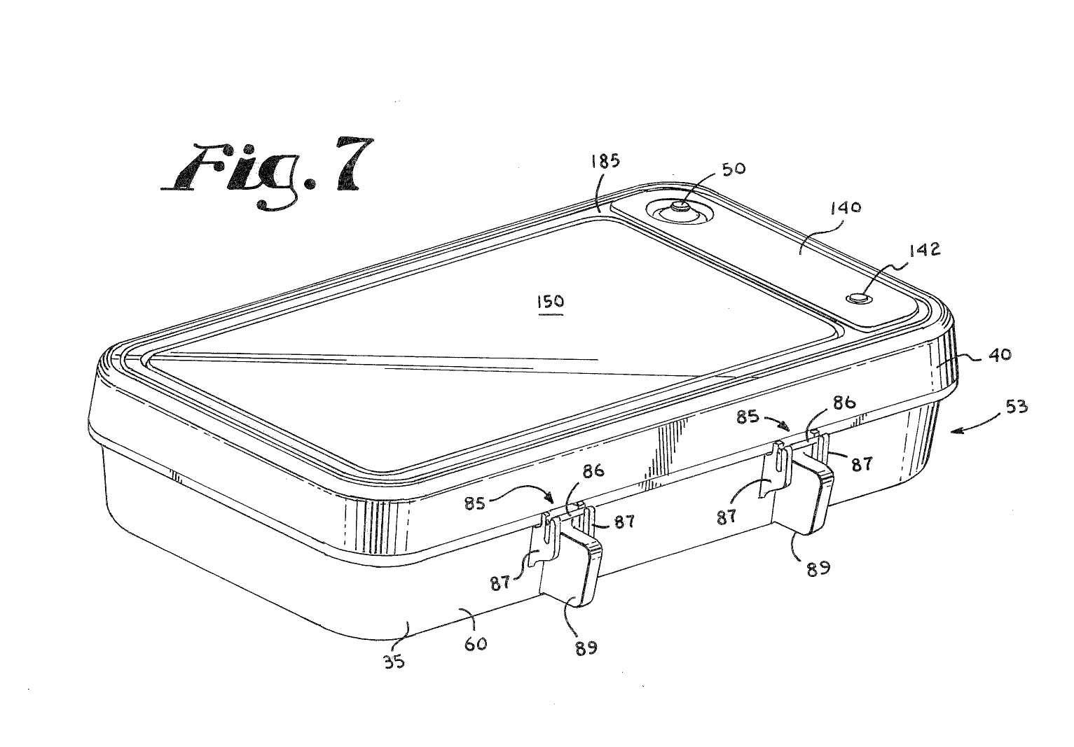

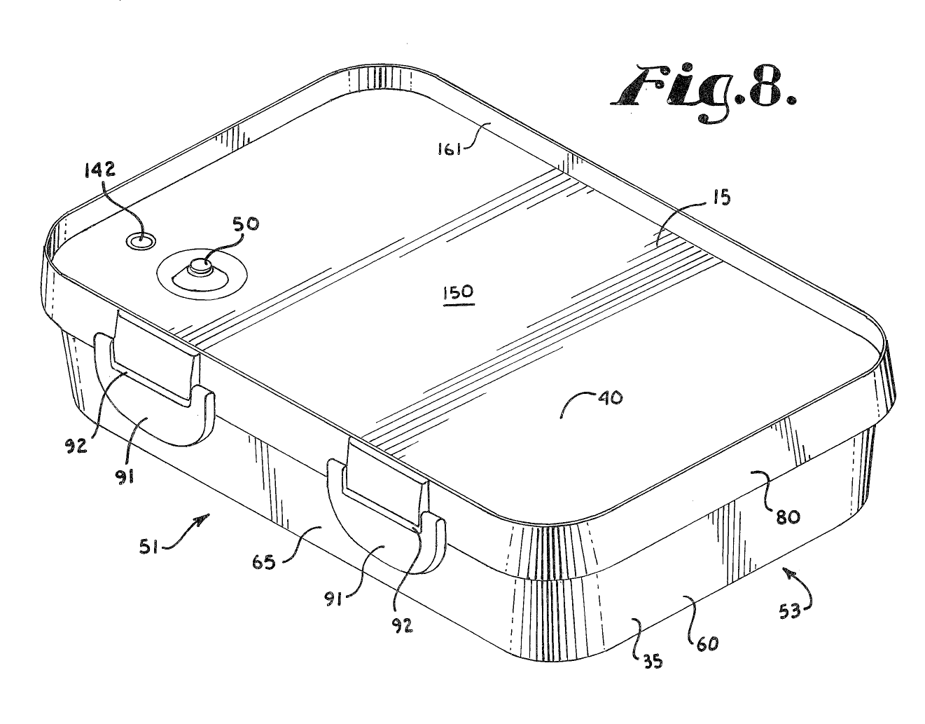

Referring to FIGS. 1-8, an apparatus, for marinating a food in a marinade, storing the food during marination, storing and keeping the food warm after cooking and supporting the food for cutting, is generally denoted by the numeral 1. The apparatus 1 includes a vacuum-sealable marination chamber, generally 5, a warming chamber, generally 10, and a cutting board 15. In some embodiments, the apparatus 1 includes a vacuum pump 20 adapted for creation of a vacuum within the marination chamber 5, such as but not limited to a hand-operated vacuum pump 20 that is well known and commonly sold for use with home with vacuum marination devices. An exemplary hand-operated vacuum pump 20 is shown in FIG. 4.

The marination chamber 5 is sized and shaped for receiving a food 25 to be marinated and a marinade, such as a marination liquid 30, therein. Foods 25 that are commonly marinated include but are not limited to meats, vegetables, and some fruits. For example, some meats, such as steak and chicken are marinated to change or enhance their flavor, and tougher cuts of meat are also marinated to increase moisture and tenderness. Marinades, or marination liquids 30, are well known in the art and typically include an acid and optionally one or more of spices, herbs, salt and oil. In some circumstances, a marinade may be a non-liquid, such as a dry rub that flavors and optionally tenderizes a food 25. At the conclusion of marination, the food 25 can be removed from the marination chamber 5, such as for cooking. After the raw food 25 has been removed, the marination chamber 5 can be closed, so as to seal any remaining marinade 30 therein, and to thereby prevent contact between a cooked food and one or more of the marinade 30 and the interior surfaces of the marination chamber 5. Separating the used marinade 30 and marination chamber 5 surfaces, which contacted the raw food 25, is particularly important since the raw food 25 could be contaminated with disease-causing bacteria. Generally, such bacteria are or can be killed during the cooking process, so that the cooked food is considered “safe” to eat. If the cooked food were to come into contact with the used marinade 30 or marination chamber 5 surfaces that contacted the raw food 25, the cooked food could be re-contaminated with the bacteria. Sealing the used marinade 30 within the marination chamber 5 can substantially prevent this problem.

The marination chamber 5 of the present invention includes a base 35 hingedly attached to a cover 40, a sealing sub-assembly, generally 45, for creating a vacuum seal between the base 35 and the cover 40, and a vacuum port 50, for attaching a vacuum pump 20 for creating a vacuum within the marination chamber 5. The marination chamber 5 further includes a front portion 51, a back portion 52 and at least one side portion 53.

The base 35 includes a floor 55 joined with one or more upstanding walls 60, or sides, that together form a lower container portion 65. The lower container portion 65 is sized and shaped to receive therein and hold the food 25 and the marination liquid 30. For example, the lower container portion 65 may be box- or bowl-shaped, such as with a substantially rectangular, circular or ovular cross-section that is taken parallel to a surface upon which the base 35 is placed, or may have any other useful shape known in the art. The lower container portion 65 includes a volume sufficient to hold between about 1, 5, 10 or 15-cups of food and about 20, 25, 30, 35 or 40-cups of food.

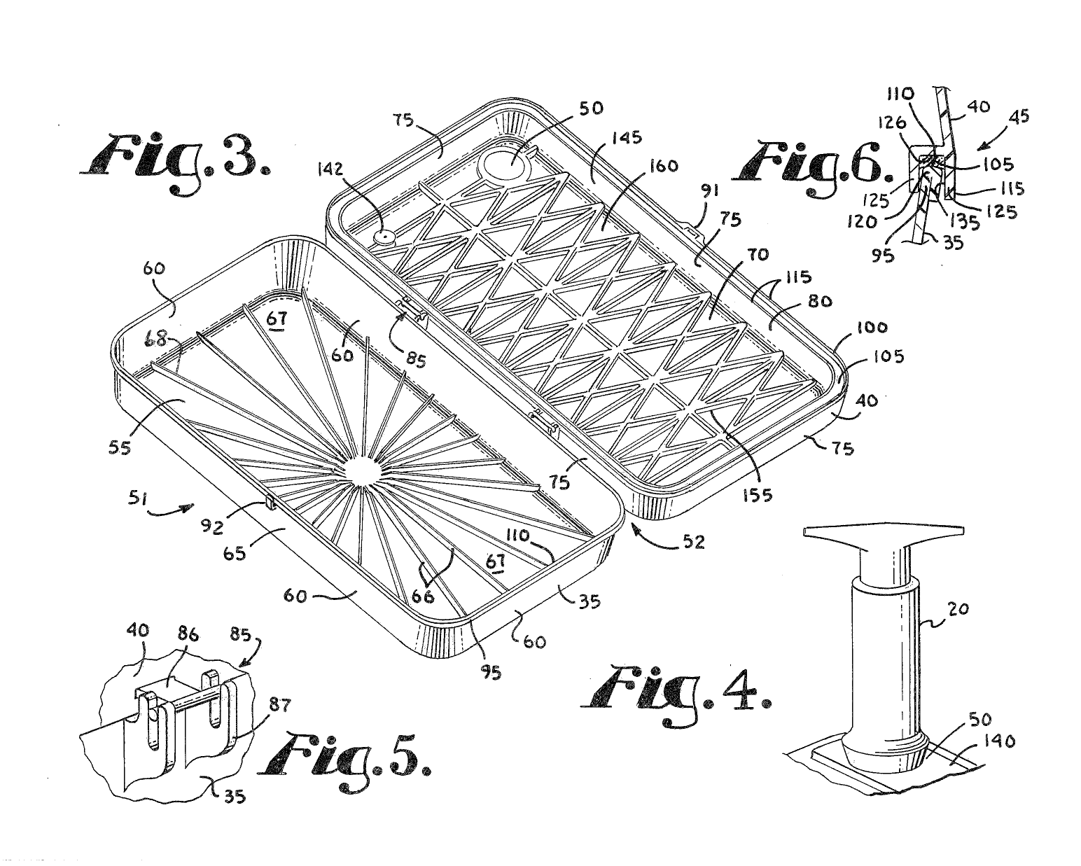

The base 35, or lower container portion 65, includes a marinating grid or rib, generally 66, sized and shaped for spacing the food 25 within the lower container portion 65 above the inner surface 67 of the floor 55, so as to enable substantial contact between a lower surface of the food 25 and the marinating liquid 30. In an exemplary embodiment, shown in FIG. 3, the marinating grid 66 is a plurality of marinating ribs 68 that extend upwardly from the floor 55. In the illustrated embodiments, the marinating ribs 68 are integral with the inner surface 67 of the lower container portion 65 and disposed in a pattern, such as but not limited to a radiating pattern or grid pattern. It is foreseen that the marinating ribs 68 may be arranged in a variety of other patterns, such as but not limited to parallel or non-parallel spaced extended rows, groups of spaced short rows, a pattern of aligned or over-lapping circles, triangles or rectangles, a maze, squares and a grid. In other embodiments, the marinating grid 66 is separate from the base 35 and removable, such as for washing.

The cover 40 is adapted for reversibly engaging the base 35, and includes a ceiling 70 joined with one or more downwardly extending walls 75, or sides, that together form an upper container portion 80. The upper container portion 80 is sized and shaped to cover the food 25 and the marination liquid 30, so as to operably mate with the base 35 and thereby prevent the marination liquid from spilling out of the lower container portion 65. For example, the upper container portion 80 may be box- or bowl-shaped, such as with a substantially rectangular, circular or ovular cross-section that is taken parallel to a surface upon which the apparatus is placed, when the marination chamber 5 is in a closed position, or may have any other useful shape known in the art, so long as the cover 40 can cooperatingly mate with the base 35 to form the marination chamber 5.

The upper container portion 80 includes a volume sufficient to hold between about 1, 5, 10 or 15-cups of food and about 20, 25, 30, 35 or 40-cups of food. In some embodiments, the volume of the upper container portion 80 is reduced with respect to the lower container portion 65. In other embodiments, the volume of the upper container portion 80 is equal to or greater than the volume of the lower container portion 65. The cover 40 includes the cutting board 15, which is discussed in greater detail below.

The base 35 and the cover 40 are releasably and pivotably joined together by hinge portions, generally 85, located on the back portion 52 of the marination chamber 5. A pair of spaced upper hinge portions 86 are located on the back of the cover 40 and a cooperating pair of spaced lower hinge portions 87 are located on the back of the base 35. The distances between the upper hinge portions 86 and between the lower hinge portions 87 are substantially equal. Accordingly, each upper hinge portion 86 is vertically aligned with a respective lower hinge portion 87, such that the respective upper and lower hinge portions 86, 87 cooperatively engage one another. This cooperative engagement enables the user to operatively pivot the cover 40 with respect to the base 35, so as to move the marination chamber 5 between the opened position shown in FIG. 3 and the closed positions shown in FIGS. 1, 7 and 8. The upper and lower hinge portions 86, 87 are adapted to snap together and apart, so that the base 35 and the cover 40 can be snapped together for marinating a food 25, and then snapped apart for cleaning. For example, in one embodiment, the base 35 and the cover 40 snap apart so that they can be easily placed in a dish washer for cleaning, or so that they can be nested together for storage in a smaller space than that required to store the apparatus 1 with the base 35 and cover 40 snapped and assembled together.

In some embodiments, at least one of the marination chamber rear wall 60 and at least one of the lower hinge portions 87 includes a leg member 89, or tip-free leg portion. The leg members 89 are sized and shaped so as to extend downwardly and slightly rearward from the rear wall 60, so as to operatively enable the marination chamber 5 to be placed in an open position substantially without tipping over. Namely, the leg members 89 are sized, shaped and located so as to enable the marination chamber cover 40 to be pivoted or rotated about an axis defined by the hinge portions 85 a distance of between about 90-degrees and about 100-degrees, relative to the base 35, whereby the marination chamber 5 is substantially prevented or blocked from tipping over when in the open position. In some further embodiments, the hinge members 89 enable the cover 40 to pivot about the axis a distance of between about 92-degrees and about 95-degrees relative to the base 35.

In some embodiments, the hinge portions 85 are integrally formed with the base 35 and cover 40, followed by operatively engaging the respective upper and lower hinge portions 86, 87 when the base 35 and the cover 40 are assembled into a marination chamber 5. In other embodiments, the hinge portions 85 are fabricated and then attached to the respective base 35 and cover 40, followed by operatively engaging the respective upper and lower hinge portions 86, 87 when the base 35 and the cover 40 are assembled into a marination chamber 5.

A lock structure or mechanism, generally 90, is located on at least one of the front portion 51 and side portions 53 of the marination chamber 5. When the marination chamber 5 is in the closed position, the lock structure 90 may be operably engaged, so as to prevent the marination chamber 5 from opening by itself and allowing the marination liquid 30 to spill out of the lower container portion 65.

The locking structure 90, such as but not limited to those shown in FIGS. 1, 3 and 8, includes cooperating complementary upper and lower lock parts 91 and 92, respectively, wherein the upper lock part 91 is associated with the cover 40 and the lower lock part 92 is associated with the base 35. The upper and lower lock parts 91, 92 may be cooperatively mated or engaged to maintain the marination chamber 5 in the closed position.

In some embodiments, the upper and lower lock parts 91, 92 are integrally formed, either wholly or in part, with the cover and base 40, 35, respectively. In other embodiments, the upper and lower lock parts 91, 92 are formed separately, either wholly or in part, from the cover and base 40, 35, and then subsequently attached thereto using methods known in the art, such as but not limited to adhesive and welding. In some embodiments, the lock structure 90 is larger or smaller than that shown in FIGS. 1, 3 and 8. The lock structure 90 may be any one of numerous structures for locking food containers that are known in the art, such as but not limited to a simple pressure-fit locking mechanism, a slotted locking tab that snaps around a cooperating button, and a more complicated twisting locking mechanism.

The marination chamber 5 includes a sealing sub-assembly 45 for forming a vacuum seal between the base 35 and the cover 40, when the marination chamber 5 is in the closed position. The sealing subassembly 45 is substantially water-tight, so as to seal the marinade 30 and any juices from the raw food 25 within the marination chamber 5. In the illustrated embodiment, the sealing sub-assembly 45 includes a base lip portion 95, a cover lip portion 100 and a gasket 105 formed of an elastic or compressible food-safe polymer. The base lip portion 95 includes an upper edge region 110 of the base walls 60. Similarly, the cover lip portion 100 includes an lower edge region 115 of the cover walls 75. When the marination chamber 5 is in the closed position, the lip portions 95 and 100 cooperatively matingly engage one another in an overlapping configuration with the gasket 115 sandwiched therebetween.

In an exemplary embodiment of the sealing sub-assembly 45, shown in FIG. 6, the upper edge region 110 is a single upstanding wall portion 120, and the lower edge region 115 includes two downwardly extending, parallel, spaced wall portions 125 and a gasket seat 126 that together define an upwardly extending groove portion 135. The gasket 105 is snugly received into the groove portion 135 so as to firmly contact the wall portions 125 and the seat 126. When the marinade chamber 5 is in the closed position, the wall portion 120 is overlappingly received between the wall portions 125 such that the wall portion 120 engages the gasket 105, and the gasket 105 is sandwiched and somewhat compressed between the wall portions 120, 125 and the gasket seat 126, thereby forming a water-tight and air-tight seal. In some embodiments, the gasket 105 is removable, such as for cleaning or replacement.

In other embodiments, the sealing sub-assembly 45 may be arranged in a reversed or upside-down order, such that the base walls 60 include a groove portion similar to groove portion 135, with the gasket 105 seated therein, and the cover 40 includes a downwardly extending wall portion similar to wall portion 120. In this reversed order, the cover downwardly extending wall portion sealingly engages the gasket 105 and overlaps with the upstanding space wall portions, so as to form the vacuum seal. It is foreseen that the sealing sub-assembly 45 may include alternative vacuum-sealing structures and configurations that may or may not include a gasket 105.

The vacuum port 50 is located on the cover 40. The vacuum port 50 extends through the cover 40 so as to join an outer surface 140 of the cover 40 with an inner surface 145 thereof. The vacuum port 50 includes a valve, such as but not limited to a one-way valve that enables air removal from the marination chamber interior and substantially blocks air entry, when the marination chamber 5 is in the closed position. In the illustrated embodiments, the vacuum port 50 is located on the cover ceiling 70. However, it is foreseen that the vacuum port 50 may be associated with one of the cover walls 75. The vacuum port 50 is operably attachable to a vacuum pump 20, for creation of the aforementioned vacuum within the closed marination chamber 5. In some embodiments, the vacuum port 50 includes a vacuum-release structure adapted for opening the vacuum port 50 and releasing a vacuum within the closed marination chamber 5.

In some embodiments, the apparatus 1 includes a vacuum pump storage subassembly (not shown), for conveniently storing the vacuum pump 20 when it is not being used. Since the cover 40 can be substantially heavier than the base 35, due to inclusion of the cutting board 15 discussed below, the base 35 may have a tendency to tip or flip over when the marination chamber 5 is open. In some embodiments, such as is discussed above, the base 35 includes a supportive leg member 89, or tip-free leg portion, whereby such tipping over is substantially blocked or eliminated. The leg member 89 may be integrally formed with the base 35, or fabricated separately and then attached to the base 35. In some embodiments, additionally or alternatively, the vacuum pump storage subassembly conveniently provides support to the cover 40, so as to substantially prevent flipping over of the base 35. In some embodiments, the vacuum pump storage subassembly is a clip structure sized and shaped to releasably engage the vacuum pump 20 for storage. In some embodiments, the vacuum pump storage subassembly is a small box-like structure that receives the vacuum pump 20 therein, when the vacuum pump 20 is not in use. When the marination chamber 5 is open, the vacuum pump storage subassembly is advantageously located on an exterior surface of the cover 40, so as to support the cover 40, so as to substantially prevent the base 35 from flipping over.

The cover 40 also includes a vacuum-indicator structure 142, adapted for indicating formation of a vacuum within the closed marination chamber 5. For example, in the illustrated embodiment, the vacuum-indicator structure 142 is vent located in the cover ceiling 70, and extending through the cover 40 so as to join an outer surface 140 of the cover 40 with an inner surface 145 thereof, with an outer dome-shaped elastic membrane. As a vacuum is formed within the chamber 5, the elastic membrane is sucked downward by removal of air within the domed portion. When the membrane is flattened against the outer surface 140, the vacuum has been formed within the chamber 5. It is foreseen that the vacuum-indicator structure 142 may have one of a variety of structures known in the art.

The cutting board 15 is associated with the cover 40, and is adapted to support the food 25 when it is cut, such as but not limited to cutting with a knife (not shown). The cutting board 15 includes an outer surface 150 of the ceiling 70 and an optional reinforcement structure 155 extending downwardly from the ceiling inner surface 160. The outer surface 150 is adapted for receiving the food 25 thereon, such as after cooking, and is sufficiently hard to resist substantial scoring by a knife when the food 25 is cut. In some embodiments, the cutting board 15 includes a drip-prevention member or structure 161 that is adapted to prevent fluids, juice or marinade 30 from dripping off of the cutting board 15 when a food 25 placed thereon. For example, as shown in FIG. 1, the drip-prevention member 161 may be a channel surrounding the perimeter of the cutting board 15. In another example, shown in FIG. 8, the drip-prevention member 161 may be an upwardly-extending lip, ledge, wall or ridge that surrounds the perimeter of the cutting board 15. Numerous variations of drip-prevention members 161 are foreseen.

In order to resist breaking due to repeated application of a downward force during food cutting, the ceiling 70 is substantially resilient, such as but not limited to being thickened with respect to the walls 75. Additionally, the reinforcement structure 155 supports the ceiling 70, thereby facilitating resistance to the aforementioned breaking. In some embodiments, the reinforcement structure 155 is integrally formed with the ceiling 70. In other embodiments, the reinforcement structure 155 is formed separately and then attached to the ceiling inner surface 160 using a method known in the art such as, but not limited to, adhesives and welding.

Referring now to FIGS. 1-2, the warming chamber 10 includes the outer top surface 140 of the cover 40 and a chamber top 165, or top portion. The chamber top 165 includes an upper wall 170 joined with one or more downwardly extending side walls 175. The chamber top 165 is sized and shaped such that a warming chamber top lip 180 removably engages the cover outer top surface 140, so as to define the warming chamber 10. In an exemplary embodiment shown in FIG. 2, the cover outer top surface 140 includes an engagement groove 185. The engagement groove 185 is sized and shaped to matingly reversibly receive therein the top lip 180 of the chamber top 165.

In some embodiments, the chamber top 165 is adapted to modulate moisture within the warming chamber 10. Accordingly, the chamber top 165 may include a vent, generally 190, and optional condensation ribs 195 that direct heat and steam, or vaporized moisture, within the warming chamber 10. In the illustrated embodiments, the vent 190 is a plurality of simple openings, bores or holes 200 joining the outer and inner surfaces 205, 210, respectively, of the chamber top 165. Steam and heat may pass through the openings 200. In some embodiments, the vent 190 may include more or fewer openings 200. It is foreseen that the vent 190 may be an adjustable vent, adapted to be moved between partially opened, fully opened and closed positions. Steam and heat within the warming chamber 10 may pass through such an adjustable vent at different rates, depending upon how much the adjustable vent is opened.

In some embodiments, at least one of the engagement groove 185 and the vent 190 is sized and shaped so as to operatively equalize the internal pressure of the warming chamber 10 relative to the external, ambient or surrounding air pressure, when the hot cooked food is cooling, so as to substantially prevent the formation of a vacuum within the warming chamber 10 that could prevent the chamber top 165, or top portion, from being easily removed from the cover 40 or the cutting board 15.

The marination chamber 5 and the warming chamber top 165 are fabricated from a food-safe polymer using methods known in the art, such as but not limited to injection molding. In preferred embodiments, the food-safe polymer is at least one of microwave-safe, dishwasher-safe, and freezer-safe. Further, the food-safe polymer may be at least one of scratch resistant, break-resistant and stain resistant.

It is to be understood that while certain forms of the present invention have been illustrated and described herein, it is not to be limited to the specific forms or arrangement of parts described and shown.

What is claimed and desired to be secured by Letters Patent is as follows:

1. An apparatus for marinating a food in a marinade, storing the food during marination, keeping the food warm after cooking, and supporting the food for cutting, the apparatus comprising:
a) a vacuum-sealable marination chamber sized and shaped for receiving a food to be marinated and a marination liquid, the marination chamber including an open position and a closed position;
b) a warming chamber; and
c) a cutting board.

2. The apparatus according to claim 1, wherein the marination chamber comprises:
a) a base;
b) a cover adapted for reversibly engaging the base;
c) a sealing sub-assembly for forming a seal between the base and the cover when the marination chamber is in the closed position; and
d) a vacuum port.

3. The apparatus according to claim 2, further comprising:
a) at least one marinating rib extending upwardly from the floor.

4. The apparatus according to claim 2, wherein:
a) the base and the cover are hingeably joined.

5. The apparatus according to claim 2, the sealing sub-assembly comprising:
a) a base lip and a cover lip, the lips being adapted for reversible overlapping mating engagement; and
b) a gasket.

6. The apparatus according to claim 2, wherein the cutting board comprises:
a) an outer surface of the cover ceiling; and
b) an inner reinforcement structure.

7. The apparatus according to claim 2, wherein the cover comprises:
a) an outer top surface with an engagement groove.

8. The apparatus according to claim 2, the base comprising:
a) at least one leg member adapted to substantially prevent the marination chamber from tipping over when in the open position.

9. The apparatus according to claim 2, the warming chamber comprising:
a) an outer top surface of the cover; and
b) a top portion reversibly engageable with the cover outer top surface.

10. The apparatus according to claim 9, the top portion comprising:
a) a vent.

11. The apparatus according to claim 9, the top portion comprising:
a) at least one condensation rib.

12. The apparatus according to claim 1, wherein
a) the marination chamber is reversibly lockable when in the closed position.

13. The apparatus according to claim 1, further comprising:
a) a food-safe polymer.

14. The apparatus according to claim 13, wherein:
a) the food-safe polymer is at least one of microwave-safe, dishwasher-safe, and freezer-safe.
